(19) United States
(12) Patent Application Publication
(10) Pub. No.: US 2002/0091659 A1
(43) Pub. Date: Jul. 11, 2002

(54) Portable viewing of medical images using handheld computers

(76) Inventors: Christopher F. Beaulieu, Los Altos, CA (US); David S. Paik, Palo Alto, CA (US); Garry E. Gold, Los Altos, CA (US); Anthony Joonkyoo Yun, Palo Alto, CA (US)

Correspondence Address: MAREK ALBOSZTA, LUMEN INTELLECTUAL PROPERTY SERVICES, SUITE 110, 45 CABOT AVENUE, SANTA CLARA, CA, 95051, US

(21) Appl. No.: 09/954,134

(22) Filed: Sep. 12, 2001

Related U.S. Application Data
(60) Provisional application No. 60/232,070, filed on Sep. 12, 2000.

(51) Int. Cl. G06F 15/18

(52) U.S. Cl. 706/62

(57) ABSTRACT

The present invention provides an apparatus and method for viewing medical images on a handheld computer. After medical images are obtained, they could be either be transferred directly to a handheld computer or indirectly via a computer. The medical images could also be transferred from one handheld computer to another handheld computer. A conversion of medical images is performed to convert the image from a standard format to an appropriate format for the selected handheld computer. One or more interactive tools are provided for displaying the one or more converted medical images on the handheld computer. An exemplary embodiment is provided that shows the conversion of a DICOM format medical image so that it could be displayed and viewed on a personal digital assistant. The advantage of the present invention is that it allows one to obtain, view and analyze medical images completely wireless and mobile on a personalized handheld computer.

### CROSS-REFERENCE TO RELATED APPLICATIONS

This application is cross-referenced to and claims priority from U.S. Provisional application 60/232,070 filed Sep. 12, 2000, which is hereby incorporated by reference.

### FIELD OF THE INVENTION

This invention relates generally to medical image display devices and methods. More particularly, it relates to portable, handheld computers and methods for viewing medical images.

### BACKGROUND

Digital images are currently the standard format for medical images generated in modern diagnostic radiology examinations such as computed tomography (CT), magnetic resonance imaging (MRI), digital radiography, and nuclear medicine. Whereas in the past, image review and archiving was performed with hard-copy (film), current trends strongly favor entirely electronic means of image display and archival. The latter picture archiving and communications (PACS) systems are currently represented by permanent workstations networked to a central image server or to image generating devices (“scanners”).

Current handheld computers, such as personal digital assistant (PDA) devices, are very limited in their capability to display medical images because of hardware and software constraints related to both spatial resolution (display matrix size) and dynamic greyscale range (bit depth). For example, images from CT and MRI are typically on a 512×512 pixel matrix, in which each pixel has 4096 possible levels of intensity of greyscale (12 bits). The Palm Pilot V represents state of the art in greyscale PDA devices, having an image matrix of 160×160 pixels and capability of displaying 16 grey levels (4 bits). Handspring Visor devices have similar display specifications. The color Palm IIIc device displays color images (24 bits total, 8 bits for red, green and blue (RGB) channels). Display of approximately 256 grey levels is possible on the IIIc with appropriate mapping to the RGB channels. The latest Sony Clie device displays 16 bit color images on a 320×320 display. Pocket PC devices such as the Hewlett-Packard Jornada 540 have a 240×320 pixel LCD displaying 65,536 colors (16 bits).

The Digital Imaging and Communications in Medicine (DICOM) format is the most widely used file format in radiology, combining image data with header or textual information. Using this format, images generated by different devices can be stored and viewed on platforms that are vendor non-specific. Since the DICOM format is targeted for scanners, printers and workstations, there is no direct compatibility with handheld computers.

Current systems of image display are typically hard-wired to a network and are not portable. For the formal diagnostic interpretation used for billing, fixed workstations are likely to remain the primary method of review. There is, however, a significant trend towards web-based display of the images for referring clinicians and patients. Web-based medical images can be displayed on a wide range of PC's, as long as an Internet connection exists.

The prior art contains a large amount of software development for PDA's. The prior art software applications are limited to generally text-based modules targeted at patient management, billing, drug information, prescriptions, and calculator functions. Examples are www.virtmed.com, www.iScribe.com, www.medicalogic.com, www.epocrates.com, www.ephysician.com, and www.handheldmed.com.

None of the prior art solutions targeting the medical handheld computer applications have image display as one of their attributes. Accordingly, there is a need to provide a medium around which to optimize handheld computer-based medical image interactions.

### SUMMARY OF THE INVENTION

The present invention provides a program storage device and a method accessible by a computer that tangible embodies a program of instructions that are executable by the computer to perform method steps for displaying one or more medical images on a handheld computer. After medical images are obtained, they could be either be transferred directly to a handheld computer or indirectly via a computer. An example of a handheld computer is, for instance, but not limited to, a personal digital assistant. The medical images could also be transferred from one handheld computer to another handheld computer. A conversion of one or more medical images is performed to convert the image from a standard format to an appropriate format for the selected handheld computer. One or more interactive tools are provided for displaying the one or more converted medical images on the handheld computer. An exemplary embodiment is provided that shows the conversion of a DICOM format medical image so that it could be displayed and viewed on a personal digital assistant. The present invention is not limited to still images as it also includes a stream of medical images, such as a video. The conversion includes, for instance, but is not limited to, a conversion of file type, text information, image size or image depth of one or more medical images. The conversion also includes a linking of the text information of the medical image with the converted medical image. The conversion further includes an unequivocal identification and security of the converted medical images, such as being HIPPA compliant. Furthermore, the conversion includes a control over spatial and contrast resolution to optimize the converted medical images. Expert knowledge is used to provide for the conversion. The program data transfer could be obtained via a hot sync cradle, via wireless transmission means, via web server, or the like. The one or more interactive tools includes one or more image management or viewing tools to assist a user to optimally view, analyze and display the medical images. The present invention also provides a handheld computer for displaying one or more medical images. The handheld computer includes one or more interactive tools for displaying converted medical images. In addition, the handheld computer includes data transfer of medical images between a computer and the handheld computer. The computer could, for instance, also be another handheld computer. The handheld computer, further includes a conversion of the medical images from a standard format of medical images to an appropriate format for the selected handheld computer.

In view of that which is stated above, it is the objective of the present invention to provide a method to display medical images on handheld computers.

It is another objective of the present invention to provide software to display medical images on handheld computers.

It is yet another objective of the present invention to provide a handheld computer device that includes the capability of displaying medical images.

It is still another objective of the present invention to provide a conversion from a standard medical format to one compatible with a selected handheld computer both in terms of file type and image size/depth.

It is still another objective of the present invention to provide a conversion process to the extent that expert knowledge of medical images is required to perform a meaningful conversion to a format with potentially lower spatial and contrast resolution.

It is another objective of the present invention to provide unequivocal identification and security of the medical images.

It is another objective of the present invention to link associated text and medical image information.

It is another objective of the present invention to provide one or more interactive tools such as image management or viewing tools to assist a user to optimally view, analyze and display the medical images.

It is another objective of the present invention to provide data transfer between handheld computers, computer and imaging devices to exchange medical images.

It is another objective of the present invention to provide interactive tools to manage and view medical still images as well as medical videos.

The advantage of the present invention over the prior art is that the system enables one to view medical images on handheld computers. Another advantage is that the present invention is that it allows one to obtain, view and analyze medical images completely wireless and mobile on a personalized handheld computer.

### BRIEF DESCRIPTION OF THE FIGURES

The objectives and advantages of the present invention will be understood by reading the following detailed description in conjunction with the drawings, in which:

FIG. 1 shows exemplary pathways of transferring medical images according to the present invention;

FIG. 2 shows an exemplary embodiment of a Graphical User Interface (GUI) for a conversion of medical images according to the present invention;

FIG. 3 shows an exemplary embodiment of a conversion of medical images according to the present invention; and

FIG. 4 shows an exemplary embodiment of a display of a medical image and textual information according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The present invention provides an apparatus and method to display one or more medical images on a handheld computer. More particularly, the present invention provides software and a method to display one or more medical images on a handheld computer. Examples of handheld computers are, for instance, but not limited to, personal digital assistants (PDAs), Pocket PCs, eBooks, Workpads, Windows CE devices, or the like. In general, the present invention involves handheld computers that are completely mobile and wireless which display medical images.

In addition, the present invention encompasses handheld computer display devices that are personalized organizers assigned not to a group of users, but, to an individual user. For instance, the present invention could be used by a doctor reviewing and analyzing medical images while being on rounds in the hospital and not in direct access to a computer that stores these medical images, such as a hospital image database (e.g. PACS). Alternatively, the doctor could be off-site, either on the road, at a different hospital or at a patient visit, where the doctor needs to review and analyze medical images. While downloading the medical images to the handheld computer is a necessary step, the handheld computer is used as an image transportation and display mechanism, so that images could be obtained, viewed, and analyzed anywhere, analogous to voice communication with a cellular telephone. Personalization allows modification of the individual's preference according to the types of medical images most commonly utilized and allows targeting transmission to specific users.

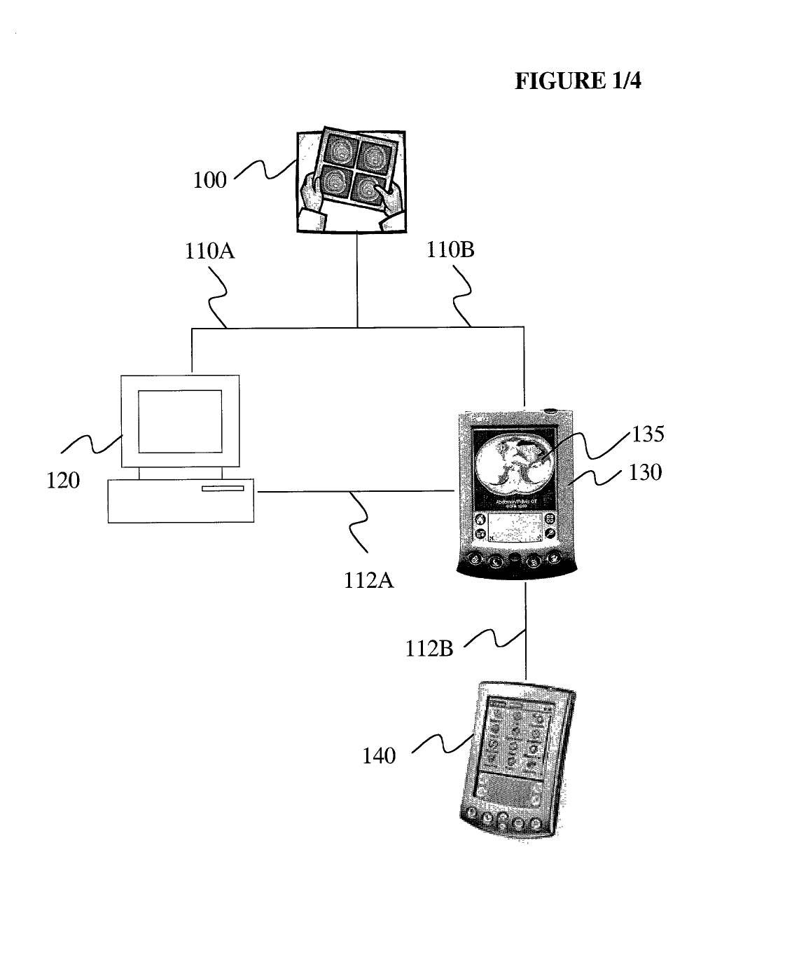

FIG. 1 shows exemplary pathways of how medical images 100 could be downloaded or transferred from and to a handheld computer. After medical images 100 are obtained, they could be either be transferred directly 110B to a handheld computer 130 or indirectly 110A via a computer 120. In case of a direct transfer 110B, the imaging device that obtained images 100 includes any type of data transfer means. In case of indirect transfer 112A, the imaging device does not necessarily include any data transfer means and first the images need to be stored in, for instance, a hospital image database (e.g. PACS), and then transferred 112A from computer 120 to handheld computer 130. Computer 120 could, for instance, be a workstation, a Personal Computer (PC), a Macintosh (MAC) or a server. The present invention also includes data transfer 112B between two different handheld computers as is shown between handheld computer 130 and handheld computer 140. Data transfer 110A, 110B, 112A and 112B of medical images 100 between devices 120,130, 140 and imaging device (not shown) is accomplished by either a network connection, hardware syncing (such as a hotsync data transfer via a cradle) or a wireless connection means. The wireless connection means could, for instance, be an infrared data transfer or wireless communication as is known for wireless voice and data communication. Data transfer is also accomplished via a web server using, for instance, standard TCP/IP protocols and a web browser. In addition, the present invention also includes data transfer using portable storage devices, such as a memory stick, which could be used to transfer and/or store the medical images.

Examples of medical images 100 are, for instance, medical radiological images, however, the present invention also includes similar type of medical images including digitized pathology slides, patients photographs, as used in dermatology, or recordings of medical video as in sonography or cine angiography. In other words, the present invention involves medical still images as well as a stream of medical images that are displayed in a sequence. An example of a stream of medical images is a video. Although, the present invention focuses on medical images, it is not limited to these medical images since it could also be used to display any type of medical data either in combination with the medical image or separate from the medical image.

To display on current handheld computers, medical images 100 must be converted from a standard or current format of medical images, such as a DICOM format, to one that is compatible with and appropriate for the handheld computer (e.g. image 135) both in terms of file type and image size/depth. This conversion could either be accomplished at computer 120 before transferring the medical images 100 to the handheld computer 120 or at handheld computer 120 itself. In addition, the handheld computer 120 may serve as a courier device for the original images 100, even though display of the full fidelity image data may not be possible due to intrinsic hardware limitations.

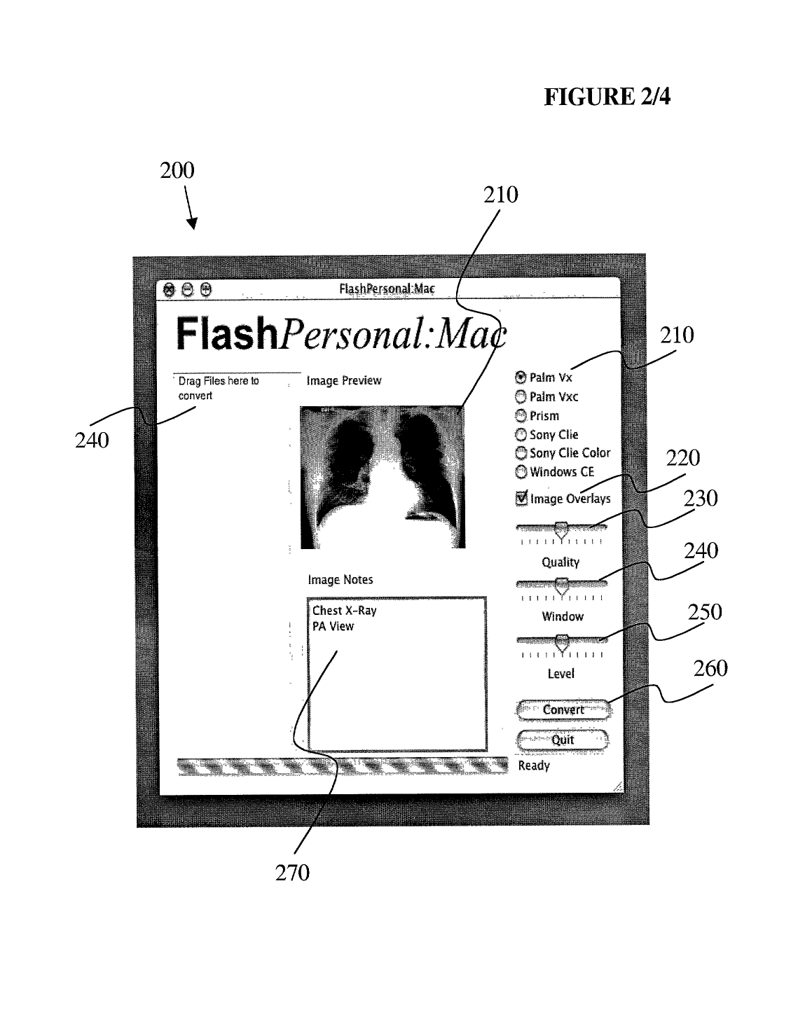

FIG. 2 shows an exemplary embodiment of a conversion of a medical image 210 using graphical user interface (GUI) 200. GUI 200 provides different options that allows for an appropriate conversion to a particular handheld computer such as 210. GUI 200 shows different options of handheld computer such as, but not limited to, Palm Vx, Palm Vxc, Prism, Sony Clie, Sony Clie Color, mobile Linux devices, or Windows CE. GUI 200 also shows different options to control the image overlays 220, image quality 230, image window 240, or image level 250. These options enables one to control the spatial and contrast resolution to optimize medical image 210. GUI 200 allows for a conversion 260 of different images which could be retrieved using a drag and drop area 240. GUI 200 also includes a conversion of file type (not shown), text information, e.g. 270, or any other relevant information that is part of image 210. In case of a DICOM format image, the header information or textual information could be parsed from the image and after the image is converted to the appropriate format for the selected handheld computer, such as 210, be clustered to user defined text information and linked to the converted medical image. An example of a DICOM textual information file or header is shown in Table 1, showing just 1% of an exemplary DICOM header file. The present invention provides the combination of converting medical images as well as parsing and linking text information.

TABLE 1

| | |
|---|---|
| (0008,0052) | Query/Retrieve Level CS 1 |
| (0008,0054) | Retrieve AE Title AE 1-n |
| (0008,0056) | Instance Availability CS 1 |
| (0008,0058) | Failed SOP Instance UID List UI 1-n |
| (0008,0060) | Modality CS 1 |
| (0008,0061) | Modalities in Study CS 1-n |
| (0008,0064) | Conversion Type CS 1 |
| (0008,0068) | Presentation Intent Type CS 1 |
| (0008,0070) | Manufacturer LO 1 |
| (0008,0080) | Institution Name LO 1 |
| (0008,0081) | Institution Address ST 1 |
| (0008,0082) | Institution Code Sequence SQ 1 |
| (0008,0090) | Referring Physician's Name PN 1 |
| (0008,0092) | Referring Physician's Address ST 1 |
| (0008,0094) | Referring Physician's Telephone Numbers SH 1-n |
| (0008,0100) | Code Value SH 1 |
| (0008,0102) | Coding Scheme Designator SH 1 |
| (0008,0103) | Coding Scheme Version SH 1 |
| (0008,0104) | Code Meaning LO 1 |
| (0008,0052) | Query/Retrieve Level CS 1 |
| (0008,0054) | Retrieve AE Title AE 1-n |
| (0008,0056) | Instance Availability CS 1 |
| (0008,0058) | Failed SOP Instance UID List UI 1-n |
| (0008,0060) | Modality CS 1 |
| (0008,0061) | Modalities in Study CS 1-n |
| (0008,0064) | Conversion Type CS 1 |
| (0008,0068) | Presentation Intent Type CS 1 |
| (0008,0070) | Manufacturer LO 1 |
| (0008,0080) | Institution Name LO 1 |
| (0008,0081) | Institution Address ST 1 |
| (0008,0082) | Institution Code Sequence SQ 1 |
| (0008,0090) | Referring Physician's Name PN 1 |
| (0008,0092) | Referring Physician's Address ST 1 |
| (0008,0094) | Referring Physician's Telephone Numbers SH 1-n |
| (0008,0100) | Code Value SH 1 |
| (0008,0102) | Coding Scheme Designator SH 1 |
| (0008,0103) | Coding Scheme Version SH 1 |
| (0008,0104) | Code Meaning LO 1 |
| (0008,0105) | Mapping Resource CS 1 |
| (0008,0106) | Context Group Version DT 1 |
| (0008,0107) | Context Group Local Version DT 1 |
| (0008,010B) | Code Set Extension Flag CS 1 |
| (0008,010C) | Private Coding Scheme Creator UID UI 1 |
| (0008,010D) | Code Set Extension Creator UID UI 1 |
| (0008,010F) | Context Identifier CS 1 |
| (0008,2230) | Primary Anatomic Structure Modifier |
| (0008,2240) | Transducer Position Sequence SQ 1 |
| (0008,2242) | Transducer Position Modifier Sequence SQ 1 |
| (0008,2244) | Transducer Orientation Sequence SQ 1 |
| (0008,2246) | Transducer Orientation Modifier Sequence SQ 1 |
| (0008,4000) | Comments RET |
| Tag Name | |
| VR VM | |
| (0010,0010) | Patient's Name PN 1 |
| (0010,0020) | Patient ID LO 1 |
| (0010,0021) | Issuer of Patient ID LO 1 |
| (0010,0030) | Patient's Birth Date DA 1 |
| (0010,0032) | Patient's Birth Time TM 1 |
| (0010,0040) | Patient's Sex CS 1 |
| (0010,0050) | Patient's Insurance Plan Code Sequence SQ 1 |
| (0010,1000) | Other Patient IDs LO 1-n |
| (0010,1001) | Other Patient Names PN 1-n |
| (0010,1005) | Patient's Birth Name PN 1 |
| (0010,1010) | Patient's Age AS 1 |
| (0010,1020) | Patient's Size DS 1 |
| (0010,1030) | Patient's Weight DS 1 |
| (0010,1040) | Patient's Address LO 1 |
| (0010,1050) | Insurance Plan Identification RET |
| (0010,1060) | Patient's Mother's Birth Name PN |

Furthermore, the present invention securely links the text information with the source medical image, to provide unequivocal image identification and security so that the patient/doctor confidentiality is maintained. More specifically, this identification and security is, for instance, HIPPA (Health Insurance Portability and Accountability Act) compliant. The linking of the present invention could include clustering text and image information into the image during the conversion process, or conversion of separate layers containing the image and text information. The present invention provides one with control over the output matrix size and image contrast (window/level) in order to optimize and to enable conversions directed at a variety of handheld computers.

The present invention encompasses the conversion process to the extent that expert knowledge of medical images is required to perform a meaningful conversion to a format with potentially lower spatial and contrast resolution. Depending on the imaging modality, body region and pathology of interest, dedicated window (W) and Level (L) settings need to be determined and validated by experts. For example, a CT study of the chest to display pulmonary nodules would require display at “lung” W/L settings, represented typically by 1500/−500 W/L settings in Hounsfield units. Similarly, a CT study of the brain or an MR study of the knee would each require specialized W/L settings. The present invention provides for interactive manipulation of W/L, allowing a user to adjust the image display on the handheld computer in order to make use of the full intensity range of the medical images.

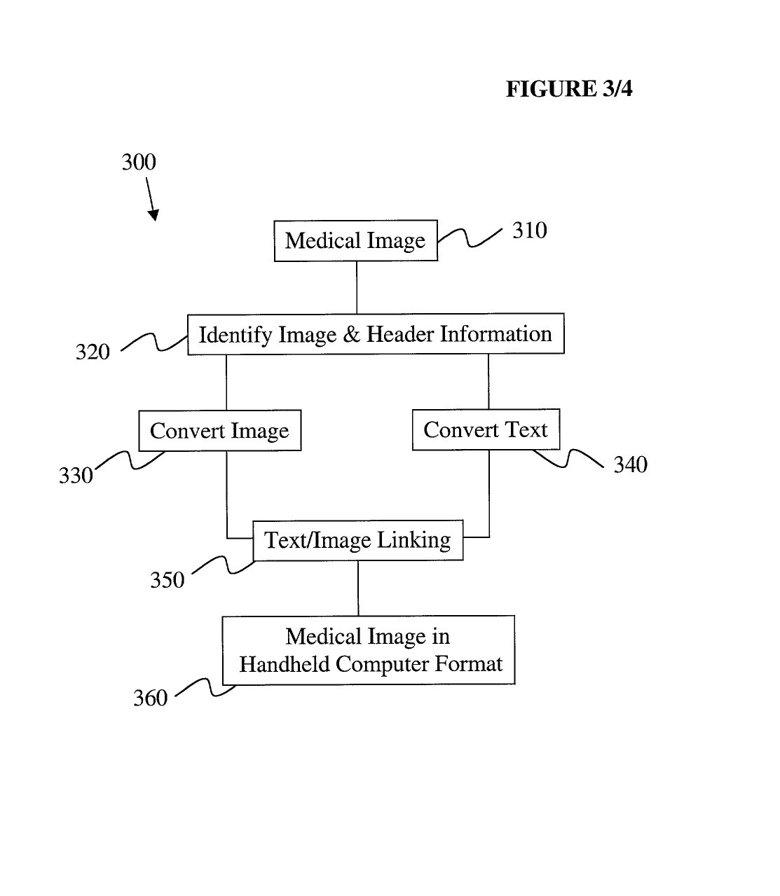

An exemplary embodiment of a conversion according to the present invention is shown in FIG. 3. For example, consider the conversion of, for instance, a DICOM type image file 310 to a format compatible 360 with, for instance, a Palm Vx device. Conversion includes an initial step of interpreting the byte size of the DICOM file to identify 320 the image portion and the header portion. The image portion, typically represented by a 512×512 matrix of pixels each 12 bits in greyscale depth, is then converted to a 160×160 matrix with 4 bits/pixel, using interpretation of the greyscale histogram and radiological knowledge to remap or convert 330 the greyscale intensities. The header portion is interpreted for fields specified by the preferences of the user to extract or convert 340 a subset of information pertinent to the imaging study, patient, and the viewing physician. For example, patient name, medical record number, study date, imaging modality, slice thickness, and use of contrast material might be selected. Subsequently, the converted image portion 330 and selected/converted header information 340 are recombined or linked 350 into a new image file 360 with a unique filename and written to disk. This file could, for example, be of the .pdb format. Note that since both the image resampling and the header extraction process occur in RAM, there is never a separation of image and header information, thereby maintaining data integrity. Note also that the user may prefer not to resample the original image data, but may wish to display by panning or zooming the entire image matrix on the handheld. Similarly, processing on the handheld device itself may be used to remap greyscale intensities to 4 bit ranges for display, thereby maintaining fidelity of the full image data. Finally, it is important to realize that this example refers to a specific, commercially available handheld computer, and the conversion process is adaptable to a wide range of current and future handheld computers.

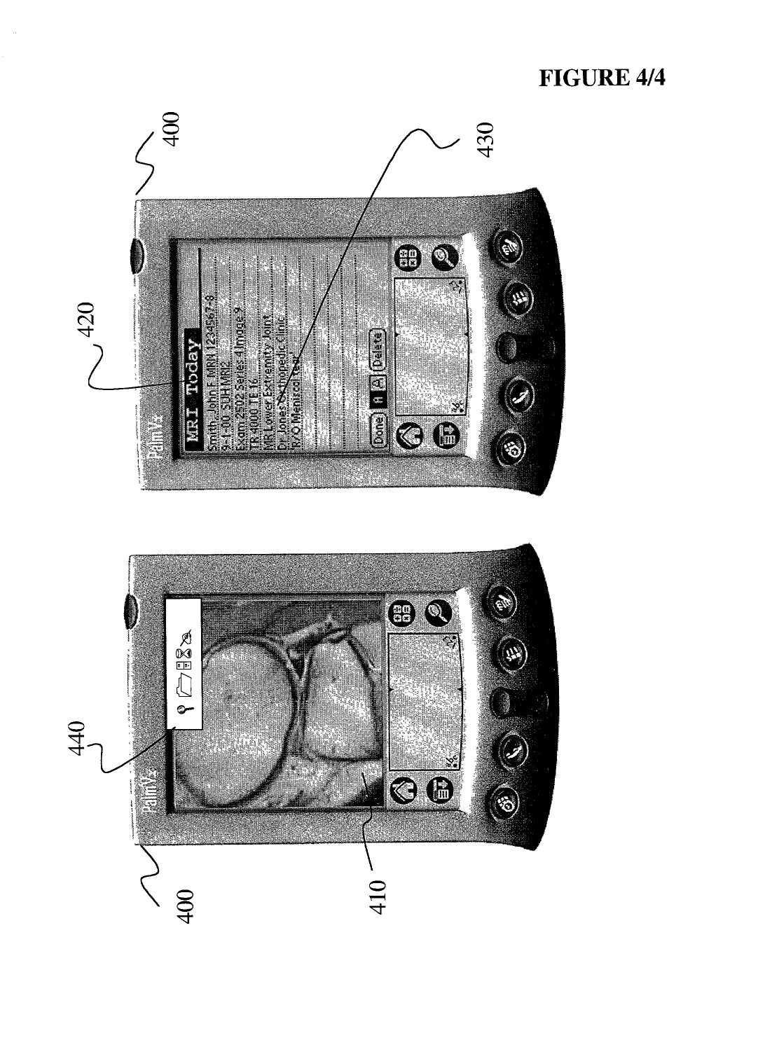

FIG. 4 provides an exemplary embodiment of a medical image 410 displayed on handheld computer 400. FIG. 4 also shows text information 420 and 430 displayed on handheld computer 400. Text 420 is an example of a patient name and text 430 is an example of associated image text data. The present invention is not limited to the type of text information that is associated with the medical image. The present invention enables one to use one or more interactive tools, as illustrated by 440, that allows for displaying, managing, (re)-viewing and analyzing the medical images. As an example, the present invention includes tools such as panning, or zooming in/out on areas of interest. However, the present invention is not limited to these exemplary tools. Other interactive tools include: (1) a list-based browser of handheld computer image contents with interactive sorting capabilities according to patient name, diagnosis, modality, date, referring physician, etc.; (2) image management tools, used to tag images for semi-permanent storage, renaming, or movement to within another handheld computer application such as an interactive slide show; (3) a record of modified or otherwise annotated images for later transmission to other handheld computers or printing; and (4) methods for wireless secondary transmission of images to another handheld computer or computer.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For instance, while the present invention describes the display and management of two-dimensional images, the present invention is not limited to stack or cine display, display of streaming video information, and, eventually, three-dimensional rendering on a handheld computer. Furthermore, while the present invention describes image display on a local device, secondary transfer of image data to another user (e.g. via infrared technology), to a printer, or back to a PC is included in the present invention. While the emphasis is on utilization of the handheld computer for clinical practice, the present invention also encompasses modules that would include medical images primarily as a teaching aid, as in a tutorial of anatomy or selected radiological knowledge. Such modules could be downloaded from a computer or loaded from compact flash (CF) memory cards or a handheld computer based micro-drive.

All such variations are considered to be within the scope and spirit of the present invention as defined by the following claims and their legal equivalents.

What is claimed is:

1. A program storage device accessible by a computer, tangible embodying a program of instructions executable by said computer to perform method steps for displaying one or more medical images on a handheld computer, said methods steps comprising of:
(a) providing a conversion of said one or more medical images from a standard format of said one or more medical images to an appropriate format for said handheld computer;
(b) providing a data transfer of said one or more converted medical images between said computer and said handheld computer; and
(c) providing one or more interactive tools for displaying said one or more converted medical images on said handheld computer.

2. The program storage device as set forth in claim 1, wherein said handheld computer is a personal digital assistant.

3. The program storage device as set forth in claim 1, wherein said standard format is a DICOM type format.

4. The program storage device as set forth in claim 1, wherein said one or more images is a stream of medical images.

5. The program storage device as set forth in claim 1, wherein said step of providing a conversion comprises the step of providing a conversion of file type, text information, image size or image depth of said one or more medical images.

6. The program storage device as set forth in claim 5, wherein said step of providing a conversion comprises the step of linking said text information with said one or more converted medical images.

7. The program storage device as set forth in claim 1, wherein said step of providing a conversion comprises the step of providing unequivocal identification and security of said one or more converted medical images.

8. The program storage device as set forth in claim 7, wherein said unequivocal identification and security is HIPPA compliant.

9. The program storage device as set forth in claim 1, wherein said step of providing a conversion comprises the step of providing control over spatial and contrast resolution to optimize said one or more converted medical images.

10. The program storage device as set forth in claim 1, wherein said step of providing a conversion comprises the step of using expert knowledge for said conversion.

11. The program storage device as set forth in claim 1, wherein said data transfer is via a hot sync cradle.

12. The program storage device as set forth in claim 1, wherein said data transfer is via wireless transmission means.

13. The program storage device as set forth in claim 1, wherein said data transfer is via web server.

14. The program storage device as set forth in claim 1, wherein said one or more interactive tools comprises one or more image management tools.

15. The program storage device as set forth in claim 1, wherein said one or more interactive tools comprises one or more image viewing tools.

16. A method of displaying one or more medical images on a handheld computer, comprising:
(a) providing a conversion of said one or more medical images from a standard format of said one or more medical images to an appropriate format for said handheld computer;
(b) providing a data transfer of said one or more converted medical images between a computer and said handheld computer; and
(c) providing one or more interactive tools for displaying said one or more converted medical images on said handheld computer.

17. The method as set forth in claim 16, wherein said handheld computer is a personal digital assistant.

18. The method as set forth in claim 16, wherein said standard format is a DICOM type format.

19. The method as set forth in claim 16, wherein said one or more images is a stream of medical images.

20. The method as set forth in claim 16, wherein said step of providing a conversion comprises the step of providing a conversion of file type, text information, image size or image depth of said one or more medical images.

21. The method as set forth in claim 20, wherein said step of providing a conversion comprises the step of linking said text information with said one or more converted medical images.

22. The method as set forth in claim 16, wherein said step of providing a conversion comprises the step of providing unequivocal identification and security of said one or more converted medical images.

23. The method as set forth in claim 22, wherein said unequivocal identification and security is HIPPA compliant.

24. The method as set forth in claim 16, wherein said step of providing a conversion comprises the step of providing control over spatial and contrast resolution to optimize said one or more converted medical images.

25. The method as set forth in claim 16, wherein said step of providing a conversion comprises the step of using expert knowledge for said conversion.

26. The method as set forth in claim 16, wherein said data transfer is via a hot sync cradle.

27. The method as set forth in claim 16, wherein said data transfer is via wireless transmission means.

28. The method as set forth in claim 16, wherein said data transfer is via web server.

29. The method as set forth in claim 16, wherein said one or more interactive tools comprises one or more image management tools.

30. The method as set forth in claim 16, wherein said one or more interactive tools comprises one or more image viewing tools.

31. A program storage device accessible by a handheld computer, tangible embodying a program of instructions executable by said handheld computer to perform method steps for displaying one or more medical images on said handheld computer, said methods steps comprising of:
(a) providing a data transfer of said one or more medical images between a computer and said handheld computer;
(b) providing a conversion of said one or more medical images from a standard format of said one or more medical images to an appropriate format for said handheld computer; and
(c) providing one or more interactive tools for displaying said one or more converted medical images on said handheld computer.

32. The program storage device as set forth in claim 31, wherein said computer is another handheld computer.

33. The program storage device as set forth in claim 32, wherein said another handheld computer is a personal digital assistant.

34. The program storage device as set forth in claim 31, wherein said handheld computer is a personal digital assistant.

35. The program storage device as set forth in claim 31, wherein said standard format is a DICOM type format.

36. The program storage device as set forth in claim 31, wherein said one or more images is a stream of medical images.

37. The program storage device as set forth in claim 31, wherein said step of providing a conversion comprises the step of providing a conversion of file type, text information, image size or image depth of said one or more medical images.

38. The program storage device as set forth in claim 37, wherein said step of providing a conversion comprises the step of linking said text information with said one or more converted medical images.

39. The program storage device as set forth in claim 31, wherein said step of providing a conversion comprises the step of providing unequivocal identification and security of said one or more converted medical images.

40. The program storage device as set forth in claim 39, wherein said unequivocal identification and security is HIPPA compliant.

41. The program storage device as set forth in claim 31, wherein said step of providing a conversion comprises the step of providing control over spatial and contrast resolution to optimize said one or more converted medical images.

42. The program storage device as set forth in claim 31, wherein said step of providing a conversion comprises the step of using expert knowledge for said conversion.

43. The program storage device as set forth in claim 31, wherein said data transfer is via a hot sync cradle.

44. The program storage device as set forth in claim 31, wherein said data transfer is via wireless transmission means.

45. The program storage device as set forth in claim 31, wherein said data transfer is via web server.

46. The program storage device as set forth in claim 31, wherein said one or more interactive tools comprises one or more image management tools.

47. The program storage device as set forth in claim 31, wherein said one or more interactive tools comprises one or more image viewing tools.

48. A method of displaying one or more medical images on a handheld computer, comprising:
(a) providing a data transfer of said one or more medical images between a computer and said handheld computer;
(b) providing a conversion of said one or more medical images from a standard format of said one or more medical images to an appropriate format for said handheld computer; and
(c) providing one or more interactive tools for displaying said one or more converted medical images on said handheld computer.

49. The method as set forth in claim 48, wherein said computer is another handheld computer.

50. The method as set forth in claim 49, wherein said another handheld computer is a personal digital assistant.

51. The method as set forth in claim 48, wherein said handheld computer is a personal digital assistant.

52. The method as set forth in claim 48, wherein said standard format is a DICOM type format.

53. The method as set forth in claim 48, wherein said one or more images is a stream of medical images.

54. The method as set forth in claim 48, wherein said step of providing a conversion comprises the step of providing a conversion of file type, text information, image size or image depth of said one or more medical images.

55. The method as set forth in claim 54, wherein said step of providing a conversion comprises the step of linking said text information with said one or more converted medical images.

56. The method as set forth in claim 48, wherein said step of providing a conversion comprises the step of providing unequivocal identification and security of said one or more converted medical images.

57. The method as set forth in claim 56, wherein said unequivocal identification and security is HIPPA compliant.

58. The method as set forth in claim 48, wherein said step of providing a conversion comprises the step of providing control over spatial and contrast resolution to optimize said one or more converted medical images.

59. The method as set forth in claim 48, wherein said step of providing a conversion comprises the step of using expert knowledge for said conversion.

60. The method as set forth in claim 48, wherein said data transfer is via a hot sync cradle.

61. The method as set forth in claim 48, wherein said data transfer is via wireless transmission means.

62. The method as set forth in claim 48, wherein said data transfer is via web server.

63. The method as set forth in claim 48, wherein said one or more interactive tools comprises one or more image management tools.

64. The method as set forth in claim 48, wherein said one or more interactive tools comprises one or more image viewing tools.

65. A handheld computer for displaying one or more medical images, comprising:
(a) one or more interactive tools for displaying said one or more converted medical images on said handheld computer; and
(b) a data transfer of said one or more medical images between a computer and said handheld computer.

66. The handheld computer as set forth in claim 65, wherein said computer is another handheld computer.

67. The handheld computer as set forth in claim 66, wherein said another handheld computer is a personal digital assistant.

68. The handheld computer as set forth in claim 65, wherein said handheld computer is a personal digital assistant.

69. The handheld computer as set forth in claim 65, wherein said one or more images is a stream of medical images.

70. The handheld computer as set forth in claim 65, further comprising a conversion of said one or more medical images from a standard format of said one or more medical images to an appropriate format for said handheld computer.

71. The handheld computer as set forth in claim 70, wherein said standard format is a DICOM type format.

72. The handheld computer as set forth in claim 70, wherein said conversion comprises a conversion of file type, text information, image size or image depth of said one or more medical images.

73. The handheld computer as set forth in claim 72, wherein said conversion comprises a linking of said text information with said one or more converted medical images.

74. The handheld computer as set forth in claim 70, wherein said conversion comprises a unequivocal identification and security of said one or more converted medical images.

75. The handheld computer as set forth in claim 74, wherein said unequivocal identification and security is HIPPA compliant.

76. The handheld computer as set forth in claim 70, wherein said conversion comprises a control over spatial and contrast resolution to optimize said one or more converted medical images.

77. The handheld computer as set forth in claim 70, wherein said conversion comprises expert knowledge for said conversion.

78. The handheld computer as set forth in claim 65, wherein said data transfer is via a hot sync cradle.

79. The handheld computer as set forth in claim 65, wherein said data transfer is via wireless transmission means.

80. The handheld computer as set forth in claim 65, wherein said data transfer is via web server.

81. The handheld computer as set forth in claim 65, wherein said one or more interactive tools comprises one or more image management tools.

82. The handheld computer as set forth in claim 65, wherein said one or more interactive tools comprises one or more image viewing tools.
